(19) United States
(12) Patent Application Publication
(10) Pub. No.: US 2006/0048201 A1
(43) Pub. Date: Mar. 2, 2006

(54) Program selection system for accessing streamed media content

(76) Inventor: Thomas R. Wolzien, Grandview-On-Hudson, NY (US)

Correspondence Address: MORRISON & FOERSTER LLP, 1650 TYSONS BOULEVARD, SUITE 300, MCLEAN, VA, 22102, US

(21) Appl. No.: 10/929,542

(22) Filed: Aug. 31, 2004

(51) Int. Cl. H04N 7/173

(52) U.S. Cl. 725/109; 725/112; 725/110

(57) ABSTRACT

The disclosure relates to computer based systems and methods for selecting streamed media signals of interest. In one embodiment, the invention can include a program selection system including a user interface such as a remote control to provide interaction between a viewer and a terminal. The terminal can be in communications with a streamed media program source. The system can also include a streamed media address table or database stored in terminal memory. The streamed media address table can contain one or more online network address corresponding to an input code or channel number. Upon receiving a user input corresponding to an online address, the communications interface can then retrieve the streamed media program.

### BACKGROUND OF THE INVENTION

1. Field of the Invention

This invention relates to control systems and methods for permitting a user to select and access desired streamed media content from an online provider. More specifically, this invention relates to mapping an input code from a control device, such as a remote control, to an address of streaming media content such that activation of a key causes presentation of streamed media content residing at source indicated by the address.

2. Background

Computers, television-type displays and other electronic devices have the capability to provide an abundance of online information and content by way of online information providers such as the Internet, Intranets, or the World Wide Web. Television viewers have become more familiar with online information services and, in particular, with the capability of online information services to provide audio/video content. A growing number of TV broadcasters, advertisers and other entities have created their own online locations, e.g., websites, which are beginning to offer more audio/video content in addition to traditional text and graphics content.

As Internet transmission speeds increase, the costs of processing decline and video and audio compression improves, the prospect of transmitting large amounts of video and audio programming over the Internet becomes even more likely. Streaming video solves a long standing problem of sending video signals across online information providers such as the Internet. Previously, it could take hours to send a single video file to someone's computer since video files tend to be extremely large because they have so much information packed into them. Streaming video solves this problem by first compressing the video dramatically so that it is much smaller as it is transmitted across the online network and secondly allowing the receiving computer to start playing the video while the file is being transmitted. Because of these advances, various widely watched programming channels and live events are now or soon will be transmitted via the Internet to video and audio display devices to be viewed as they are transmitted or stored locally for later viewing. Notwithstanding these advances, currently most online communications occur merely through text and graphics. This is in contrast to the audio/video presentation of the alternative electronic medium, television.

The consumer experience in viewing video materials transmitted via the Internet typically requires that an extensive address code be entered into the browser to reach the desired site. For example, the World Wide Web requires that a uniform resource locator, i.e., URL, or Web address, be input by the user. The URL requires an indication of protocol type, the location of the host computer, the name of the Web page and the file type for each piece of content. Clearly, viewers typically cannot easily recall or identify an associated URL for a particular program. Even if they do recall the URL, it is annoying and inconvenient to type in all of the characters required by a URL or any other type of conventional online address.

Almost everyone is familiar with the convenient and ubiquitous channel scheme associated with conventional television broadcasts. A viewer need only depress one to three buttons to access a multitude of programming choices. Thus, there exists a great gap in convenience between using conventional computer tools to reach a program source and the use of the convenient and ubiquitous remote control for changing the channel on a television set.

The experience of viewing content delivered over an online communications network would be greatly enhanced if a viewer could select streamed media programs in a manner similar to the convenient manner in which broadcast, cable and satellite television channels can be selected. What is needed is a system and method that allows accessing streamed media programs transmitted over an online information network, such as the Internet, to be as user friendly as entering channel numbers on a remote for broadcast television.

### BRIEF SUMMARY OF THE INVENTION

The present invention is directed to a computer based system and method for selecting streamed media signals of interest. In particular, the present invention provides a storage device that stores a media address table containing one or more corresponding input or key codes mapped to streamed media source addresses. These addresses may be in any one of many different formats associated with protocols as conventionally known in the art including uniform resource identifiers (URIs), uniform resource locators (URLs), or any online information provider address. The entries in the streamed media address table may also include a time stamp indicating either when to retrieve the program or when the program should be displayed to the viewer.

Preferably, the user enters a simple input code into a user interface device such as by depressing one or more keys in a remote controller. This input code may be provided to the viewer on a list of many selectable codes on a display screen, such as a program guide, indicating the “channel” for each program. Alternatively, the viewer could view the guide in print media. Once the user input code is received at the receiver through a communications interface port, a controller executes a search of the streamed media address table stored in an internal or external storage device.

Upon completion of the search, the address or address code identified in the table as corresponding to the user input is loaded into a network interface, such as a browser, either immediately or at some time thereafter specified by a time stamp. At the specified time, or on a user's command, the network interface establishes a connection with host software, using, for example, TCP/IP. After the connection is established, the network interface makes a request for the selected media stream by sending the address through the connection to the server.

The server receives the transmitted address and finds the media stream signal of interest. Preferably, the server sends the media file to the viewer's machine in packets across the Internet, Intranet or other online information network. At the viewer's machine, the media is buffered and a media player may be launched on the computer. The user may now experience the media on the player as it plays out from memory. Alternatively, the media file may be saved in memory and played out at a later time by the player or at a predetermined time as indicated by the time stamp.

Further features of the present invention, as well as the structure and operation of various embodiments of the present invention are described in detail below with reference to the accompanying drawings.

### BRIEF DESCRIPTION OF THE DRAWINGS

The accompanying drawings, which are incorporated herein and form part of the specification, illustrate the present invention and together with the description, further serve to explain the principles of the invention and to enable a person skilled in the pertinent art to make and use the invention.

FIG. 1 is an illustration of a program selection system according to one embodiment of the present invention.

FIG. 2 is a block diagram of a general purpose computer system embodiment of the present invention.

FIG. 3 is an illustration depicting a data structure for a streamed media address table.

FIG. 4 is an illustration of a remote controller as the user interface device.

FIG. 5 is a flow chart diagram of a method for determining an address of a streamed media corresponding to a user input selection.

### DETAILED DESCRIPTION OF THE INVENTION

The invention includes systems and methods for selecting streaming media content sources. The invention is particularly well-suited and useful for allowing a user to quickly and conveniently enter a address code and either immediately or at some predetermined time be able to enjoy a streamed media presentation.

1. Overview of the Program Selection System

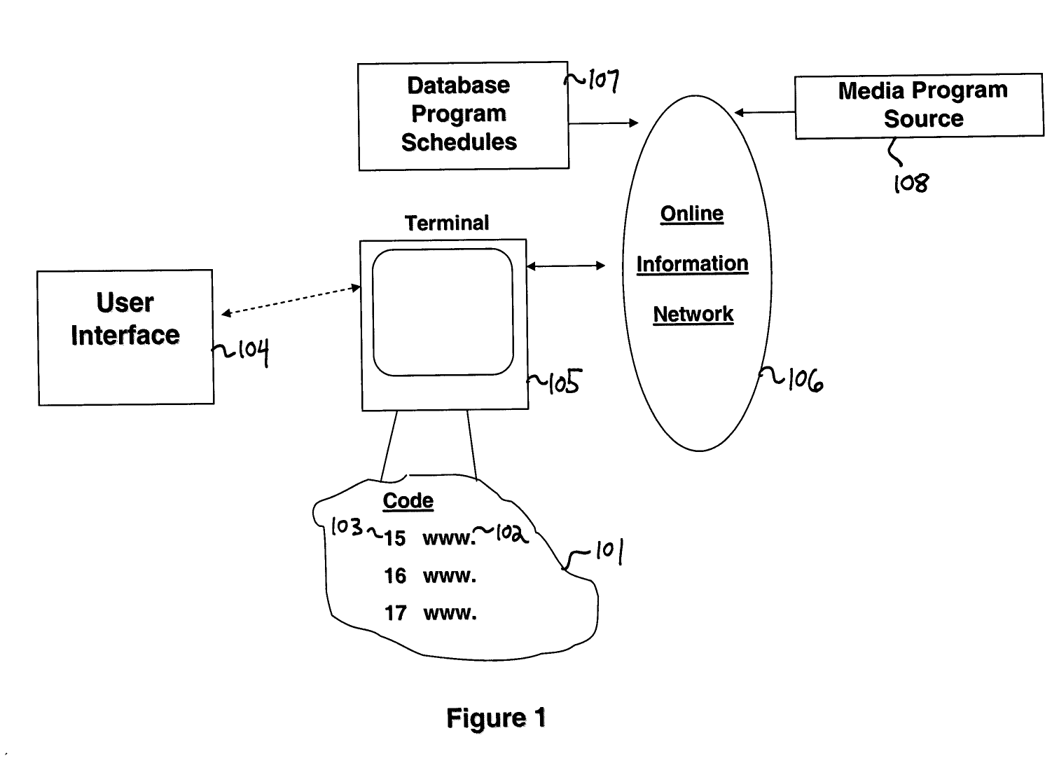

Referring to FIG. 1, a system for selecting a desired streamed audio, video or audio/video signal (hereinafter, all of which are referred to as a “streamed media signal”) will now be described according to the embodiments of the present invention. The invention, however, is not limited to these example embodiments. Other implementations of the program selection system will be apparent to persons skilled in the relevant arts based at least in part on the teachings contained herein.

The system in FIG. 1 is a high level diagram of the program selection system. The system includes a streamed media address table or database (101) stored in terminal memory. The streamed media address table (101) contains one or more online network address (102) corresponding to an input code, e.g., channel number (103). As described in greater detail below, such a table (101) may also include information describing the program associated with each address such as program type, theme, rating, amongst other indicators.

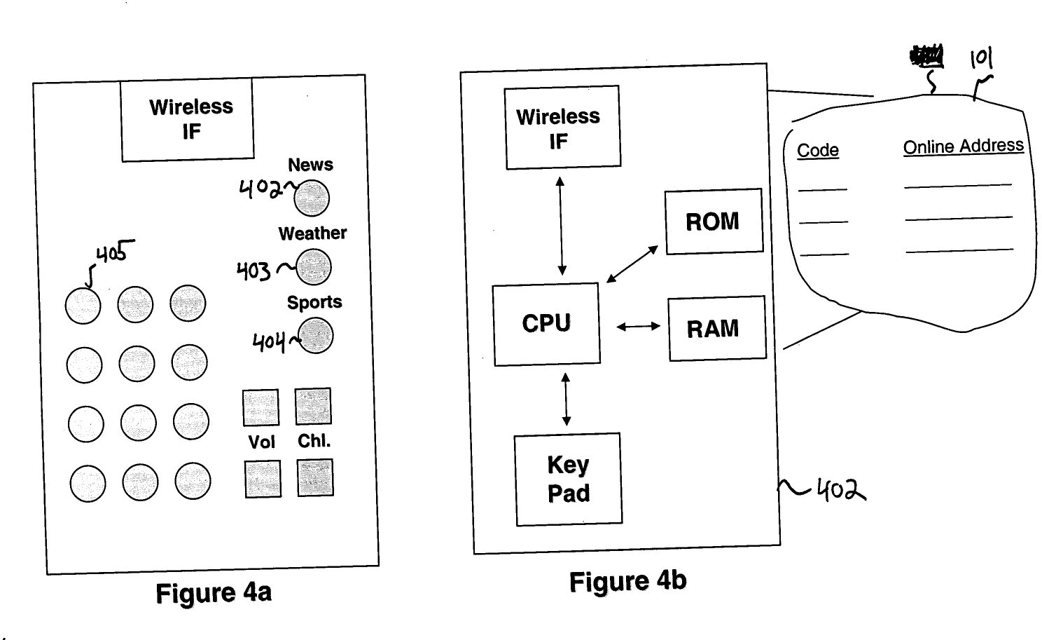

The program selection system also includes a user interface (104) such as a remote control. The user interface (104) provides interaction between the viewer and the terminal (105). The user interface (104) allows the user to enter a code by depressing one or more keys, for example, identifying prospective viewing or listening selections. The user interface (104) could be conventional remote, a customized remote such as that shown in FIG. 4, a cell phone, voice recognition system, a PDA, web tablet or a keyboard. The user interface may be connected to the terminal through any means including IF, RF, wired connection or any other conventional means known in the art. The terminal (105) could be a personal computer, a personal data assistant, wireless phone, mobile device, television, cable or satellite set top box, television, web tablet or any combinations of any of the above operably in communications with one another. The user interface (104) could also be integrated with the terminal (105) such as the keys on a laptop computer or buttons on a personal data assistant, or voice recognition hardware/software stored in terminal memory, for example.

Preferably, the terminal (105) is in communications with the streamed media program source (108) through any communications means including an online information network (106), local area network, Internet, Intranet, public switched network, cable or dBS system, or any other communications means conventionally known in the art. Alternatively, the streamed media program source (108) could be internal terminal storage or external storage locally connected to the terminal (105). The streamed media program source (108) is preferably one or more servers. The terminal (105) is also operably in communications with the program schedules database (107) which may in one embodiment include downloadable information used to either load or update the media address table (101) at the terminal (105). In another embodiment, as described in more detail below, the program schedule database (107) may actually store the media address table (101) in whole or in part. The program schedules database (107) may also include electronic program guide information as is known in the art.

2. The Terminal Configuration

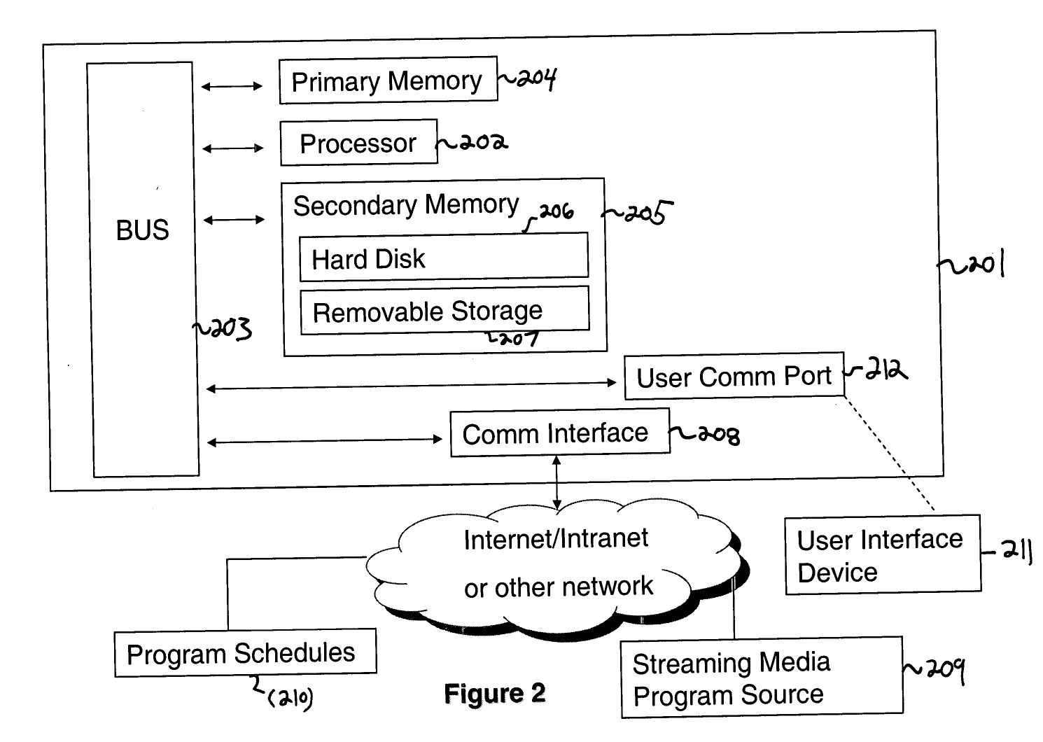

As shown in FIG. 2, the components of the program selection system can be implemented in whole or in part in the terminal (105) using components of a general purpose computer system (201). The computer system (201) includes one or more processors (202) connected to a communications bus (203). The computer system (201) also includes primary memory (204). Primary memory (204) may be random access memory (RAM), read only memory (ROM), EPROM and/or EEPROM. The computer system (201) further includes secondary memory (205). Secondary memory (205) includes, for example, hard disc drive (206) and/or removable storage (207). Removable storage (207) drive could be, for example, a floppy disc drive, a magnetic tape drive, a compact disk drive, a program cartridge and cartridge interface, a magnetic tape drive, or a removable storage unit. Although not shown, the computer system (201) could also include an audio/video card or the components associated with analog or digital set top boxes including demodulators, decoders, decompressors, amongst other components known to those skilled in the art.

Computer programs or computer control logic are stored in primary memory (204) and/or secondary memory (205). Preferably, the terminal (105) also includes streaming media software such as Microsoft MediaPlayer, Real Networks Real Player, Apple QuickTime or any other streaming media software generally known. The streamed media address table (101) and software associated with accessing data to/from the table (101) may be stored in primary memory (204) and/or secondary memory (205). Preferably, the processor (202) or other controller in the general purpose terminal (105) may operate as the program selection controller.

The computer system (201) further includes a communications interface (208). Communications interface (208) may include hardware and/or software as generally known in the art that enables the computer system (201) to send and receive content, software and data to/from external devices such as the streaming media source (209) and program schedules database (210). For example, the communications interface (208) may include a browser which is used to retrieve streamed media programs over the web, for example. The user interface (211) may be operably communicate with the communications interface (208) or have its own communications port (212).

Referring again to FIG. 2, the program selection system of the present invention may be implemented fully within the computer system (201), terminal (105) or distributed amongst multiple computer network systems. In one embodiment, the streamed media address table (101) is stored in the terminal (105). In this embodiment, the program addresses (102) may be updated remotely from the program schedules site from time to time. In another embodiment, the media address table (101) is stored at remote site such as the program schedules database (107). In this embodiment, codes entered by the user must be transmitted to the remote site for processing. The operation of the present invention in both of these embodiments is described in more detail below.

Referring again to FIG. 2, preferably the streamed media address tables (101) are generated remotely from the terminal (105) at the program schedule site (210). The program schedules site (210) serves as a central repository of the streamed media program addresses and optionally times of availability. From time to time, the media address tables (101) are updated remotely through the transfer of data from the program schedules site (210) over any conventional network.

3. The Viewer Address Table

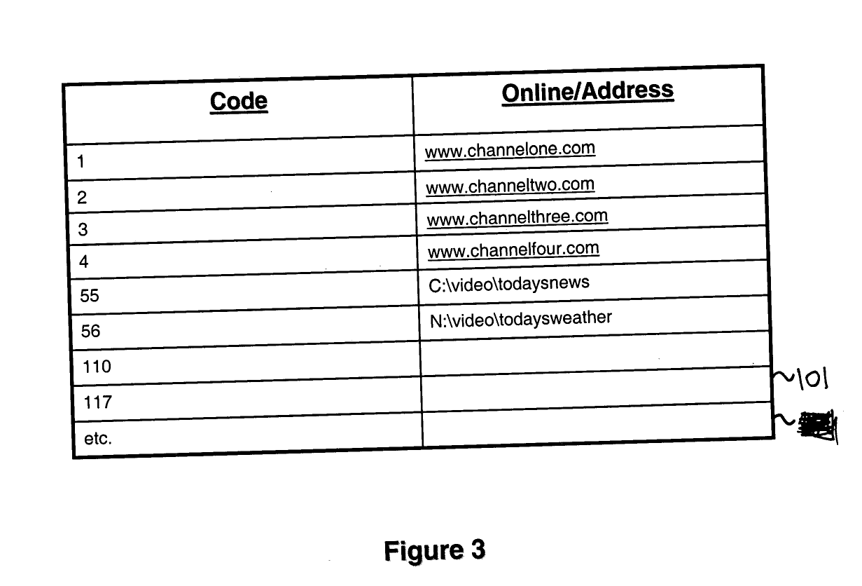

Referring to FIG. 3, a streamed media address table (101) is shown. According to one embodiment of the invention, a key on a control device can be mapped to the address of streaming media content which can include audio or video content through the use of the viewer control table shown in FIG. 3. For example, if the user depresses the key “1” on the remote or keyboard, the www.channelone.com address will be selected. The address of the media content can indicate a location either local or remote to the user. In this particular embodiment, the address is in the form of a uniform resource locator. The address can identify the location of content through the use of a Uniform Resource Identifier (URI), Universal Resource Locator (URL) or any other content location system or method known to one of ordinary skill in the art. If an address indicates a remote content location, the system of the invention can retrieve the content over a network. A typical URL looks like the following: http://www.axelbus.com/internetworks/index.html/

The mapping of a key to an address has the effect of associating the mapped key with an address such that the key represents all of the information contained in the address. As non-limiting examples, the content identified by the address can include streaming audio, video or television programming. The mapped content can include any form of streaming audio or video content. In some embodiments, the streamed programming can be encoded according to the MPEG-4 standard. One of ordinary skill in the art will recognize that a variety or encoding and/or compression techniques may be used, one example of which is MPEG-4.

A key can be associated with an address and this association can be stored in one or more streamed media address tables (101), for example. While the system described below is described with reference to a streamed media address table, (101) one of ordinary skill in the art would recognize that an association of a key and an address can take the form of a table, database, linked list or any other type of data structure stored in hardware or software that permits the association of a key with an address.

4. Remote Embodiment of the Viewer Address Table

Referring to FIGS. 4a and 4b, the system includes a control device for transmitting signals to a signal receiver and includes storing the streamed media address table (101) directly in the remote control device (402). FIG. 4a discloses the keys (402-405) on the keypad and FIG. 4b discloses the components of the control device (402). Different types of keys and methods of activation are disclosed below in connection with the control device (402). Preferably, the streamed media table (101) is stored in RAM. In some embodiments, a key on the control device can be used to represent a discrete channel through which streaming media content can be provided. A key can be activated by providing the input the key detects. FIG. 4b shows a media address table (101) mapping input codes to online address as being stored in the control device. Although not shown, the address table (101) could also include time stamps indicating either when to retrieve the indicated program at the associated address or when to display or present the program.

The control device (402) can include input keys which can be buttons, controls or other sensors sensitive to input from a user and which have the effect of identifying a channel. Some embodiments can provide keys in the form of one or more channel number buttons, e.g. “1”, “2”, “3” or in the form of content-type descriptors such as news (402), weather (403), or sports (404). In some embodiments, the key inputs can be used to sense pressure, sound or perform voice recognition. As a non-limiting example, in some embodiments, a key can be activated by giving the voice command “channel one.” Consistent with the invention, a key can also be a combination of inputs, such as two numbers in sequence. In some embodiments, the successive entry of a “5” followed by another “5” can be considered to be the key entry of “55.” Some embodiments of the control device may require that a control key such as an “ENTER” key be pressed before the key or input is transmitted to the signal receiver.

In embodiments where the streamed media address table (101) is stored in the terminal (105) instead of the remote control device (402), once a key is activated, an electronic representation of the key can be generated and encoded for transmission. Transmission of the signals from the remote control device can be through infra-red (IR), radio frequency (RF) or other wireless means. Once a key has been detected or other input received from a user, the key or input can be encoded and transmitted to the terminal (105) with any required control keys according to conventional means known to one of ordinary skill in the art. Through the use of the invention, a key on a control device (402) can be mapped to a streaming media content source such as through the media address table (101). In some embodiments, the control device (402) can include multiple keys mapped to multiple streaming media content sources.

As a non-limiting example, the association or pairing of a key with an address can be performed through a direct input device such as a keyboard, Palm Pilot or other computer. In some embodiments, addresses can be entered at a web site and then downloaded to the key address table stored on one of the aforementioned devices. Addresses can also be sent to a user's system by a content packager and recorded in the media address table (101) without requiring the intervention of the user. Keys can be mapped to addresses either by a user or keys can be pre-mapped in the control device (402). In some embodiments, the user can use the control device (402) to enter keys and addresses and map addresses to keys.

5. Operation

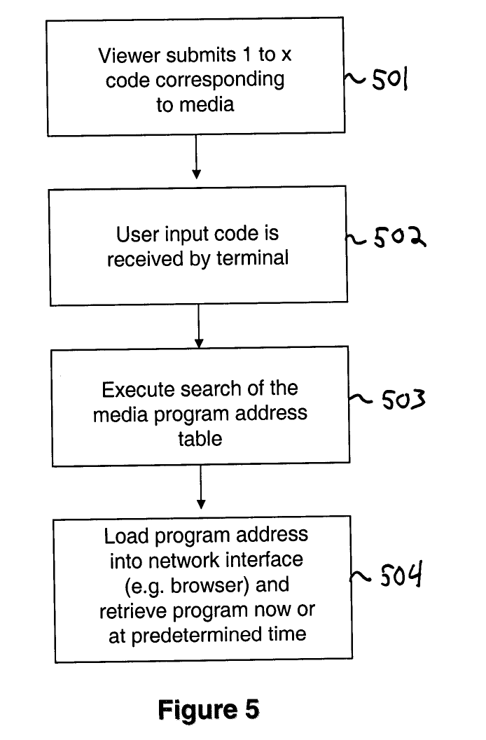

FIG. 5 shows a method of operation of the present invention. A user enters a short code into the user interface by, for example, depressing keys on a remote keypad (501). The user interface transmits the code to the terminal (502). The transmission is decoded by the terminal and the received data extracted from its carrier. The controller directed software then searches the media address table (101) to determine the online address corresponding to the user input (503). In accessing the media address table (101), the received input code is compared to entries in the address table. If a match is found for the input code, the associated address can then be placed in proper format and sent to the communications interface, such as the browser. The communications interface then retrieves the streamed media program (504). Once received, the program may be immediately played on the display screen for example using a typical media player in the terminal. Alternatively, it may be played out at some time as indicated by the time stamp in the address table.

If the media address table (101) is stored at a remote location over the online network, the signal receiver can transmit the received input code or a representation of it to the remote location, such as the program database server as shown in FIG. 2, for translation of the key to its associated address. If a match is found for the key, the associated address can then be transmitted to one of the aforementioned local devices for further processing and/or forwarding to the presentation device.

The above description is presented to enable a person skilled in the art to make and use the system, and is provided in the context of a particular application and its requirements. Various modifications to the preferred embodiments will be readily apparent to those skilled in the art, and the generic principles defined herein may be applied to other embodiments and applications without departing from the spirit and scope of the system. Thus, this system is not intended to be limited to the embodiments shown, but is to be accorded the widest scope consistent with the principles and features disclosed herein.

I claim:

1. A system for selecting a desired video signal, comprising:
a storage device for storing a video address table having at least one entry, each entry comprising at least one address code indicative of a source of a streamed video signal and at least one corresponding input code;
a controller, operably in communications with the storage device, for receiving a selected input code indicating the selection of a desired streamed video signal and associating the selected input code with an address code indicative of a source of the desired streamed video signal.

2. The system of claim 1 wherein the address code consists of one of a uniform resource indicator, a uniform resource locator, and an online address.

3. The system of claim 1 further comprising a user interface device, operably in communications with the receiver, for transmitting the selected input in response to user interaction with the control device.

4. The system of claim 1 further comprising a user device consisting of one of a keyboard, remote control, wired device, wireless device, cell phone, personal data assistant and electronic tablet.

5. The system of claim 1 wherein the source of the video signal consists of one of local storage, an Internet source, and an intranet source.

6. The system of claim 1 further comprising:
a remote control for controlling a video signal shown in a display device, the remote control comprising a video selection button for selecting the input code and a transmitter for transmitting the input code to the receiver;
a communications interface, operably in communications with the controller, for requesting the selected video signal from an Internet source using the address code from the video channel table; and
a display device for displaying the selected video signal.

7. A method for selecting streaming media content comprising:
receiving a user input selection;
accessing a video address table containing at least one entry containing at least one address code indicative of a source of a streamed video signal and at least one corresponding input code;
searching the video address table for an address code that matches to the user input selection; and
retrieving a streamed video program stored at the source indicated by the matched address code.

8. The method of claim 7 further comprising:
presenting the retrieved video program on a presentation device.

9. A computer readable medium, comprising:
computer readable code embodied in said medium for use in selecting streamed video content, the computer readable program code in said computer readable medium comprising:
a streamed video address table having one or more entries comprising at least one address code and at least one corresponding input code; and
a program of executable instructions for receiving a selected input code indicating the selection of a desired streamed video signal and associating the selected input code with an address code indicative of a source of the desired streamed video signal.

10. The computer readable medium of claim 9 wherein one or more entries includes a time stamp.

11. A method for selecting streaming audio content comprising:
receiving a user input selection;
accessing an audio address table containing at least one entry containing at least one address code indicative of a source of a streamed audio signal and at least one corresponding input code;
searching the audio address table for an address code that matches to the user input selection; and
retrieving a streamed audio program stored at the source indicated by the matched address code.

12. A system for selecting a desired video signal, comprising:
a storage device for storing a video address table having at least one entry, each entry comprising at least one address code indicative of a source of a streamed video signal and at least one corresponding input code;
a controller, operably in communications with the storage device, for receiving a selected input code indicating the selection of a desired streamed video signal and associating the selected input code with an address code indicative of a source of the desired streamed video signal; and
a program schedule device located remotely from the storage device and the controller for storing at least one address code indicative of a source of a streamed video signal and at least one corresponding input code,
wherein the video address table stored on the storage device is configured to receive at least one address code and at least one input code from the program schedule device.
